(19) United States
(12) Patent Application Publication
(10) Pub. No.: US 2016/0035185 A1
(43) Pub. Date: Feb. 4, 2016

(54) Electronic Syndicated Lottery Platform, System and Method

(71) Applicant: GTECH Corporation, Providence, RI (US)

(72) Inventors: Jason A. Barrs, Providence, RI (US); Jasmin Gladys Blackmar, Cranston, RI (US); Stefano Monterosso, Boston, MA (US); Thomas J. Napolitano, East Greenwich, RI (US); Daniel Xavier, Rumford, RI (US)

(21) Appl. No.: 14/808,162

(22) Filed: Jul. 24, 2015

Related U.S. Application Data
(60) Provisional application No. 62/031,507, filed on Jul. 31, 2014.

(51) Int. Cl. G07F 17/32

(52) U.S. Cl. CPC G07F 17/3237; G07F 17/329; G07F 17/3258; G07F 17/3276; G07F 17/3244

(57) ABSTRACT

An electronic syndicated lottery platform, system and method provides for syndicated lottery activities for groups. In aspects, with a first software module, a request is received to establish a primary syndicate wager, wherein the request includes a designation of a specific number of players or a range of a number of players to be included in a wagering group, and further includes at least one type of wagering game to be played, and further receives a designation of one or more players to be invited to join the wagering group, wherein each of the one or more players has a player transaction account. With a second software module, payment is collected for the primary syndicate wager, the wagering game to be played is registered with a game operator, and a determination is made as to whether a win has occurred. Upon a win occurring, embodiments of the system can automatically and electronically credit the player transaction accounts in the wagering group.

### FIELD OF THE INVENTION

The present invention pertains to syndicated lottery activities, and more particularly to an electronic syndicated lottery platform, system and method.

### BACKGROUND AND SUMMARY OF THE INVENTION

Regulated wagering games are common throughout the world. Typical examples are various games offered by state lotteries. Those games, which are offered on a large scale, are operated using centralized transaction processing systems to collect and/or redeem wagers. Most state lotteries and similar entities operate their own central host computing system, or have it operated by a contractor such as IGT, for example. The host computing systems are typically located within the jurisdiction of the lottery provider. The state lotteries also deploy their own client equipment to operate various channels for delivering games to player customers, such as agent-operated lottery game sales terminals, unattended lottery game sales terminals, vending machines, kiosks, electronic access via the Internet from personal computers, mobile phone access, and interactive TV terminal access, for example. They also operate, or have operated on their behalf by a contractor, their own customized administration computing systems, such as accounting, reporting, fraud control, loyalty programs, second chance games and prize redemption systems, for example.

In various embodiments, these systems can include one or multiple servers providing interactive interfaces for receiving wager requests online, receiving second chance game sign-up requests, processing and storing such requests, issuing wagering receipts, assigning and managing player accounts, processing funds for player accounts, tracking player interaction with the system and performing other administrative functions. Various types of networks can be employed, including the Internet, in order to ensure proper system availability and minimized downtime for operation.

Lottery systems and platforms can also employ loyalty and second chance game features in order to increase customer interest and reward customer loyalty. A second chance drawing can be a means for a player who did not win (or even a player who did win) in a primary drawing (e.g., MegaMillions™) or in a first instant ticket game to win at least some type of prize, which may be awarded from a separate prize pool, for example.

Lottery ticket games are known and are provided in different formats, including instant-win type games and online or drawing-based games. With an instant ticket game, a player typically scratches one or more places on a ticket to determine if he or she is a winner. With drawing-based games, a player typically selects several numbers from a pool of numbers, and a lottery drawing of numbers (such as from a bin of ping pong balls, for example) is conducted later to determine whether there are any winners. Lottery tickets can be physical tickets purchased at retailers or virtual tickets purchased and played online.

Social media is a separate and more recent phenomenon, whereby individuals can interact in a variety of ways online through social media-related web systems, such as LinkedIn™, Twitter™, MySpace™ and other sites. Various functions are available at these online sites, with a typical theme being the sharing of various types of information with a group or network of known friends and contacts.

In various aspects, the present invention provides an electronic syndicated lottery platform, system and method which can be employed for new lottery games, including games that permit participation by groups using independent personal computing devices, rule-setting and other individualized elements that may appeal to other individuals and groups.

Typically, lottery wagering is performed either by an individual or by a syndicate (also called groups or pools). An individual wager happens when a player decides to make a wager and places it with the lottery, whether in person or online. The syndicate wager works somewhat differently. In a syndicate wager, a group of people pool their lottery money together for the purpose of buying as many tickets as possible, increasing their odds of winning. There is generally a head (otherwise known as syndicate manager or office pool manager) that is responsible for collecting the money from the other members of the group, deciding what the base wager will be and how much each share is worth and finally placing the wagers. The winnings are then generally shared equally or on a pro rata basis between the group members.

In accordance with aspects of the present invention, public and private groups using one or more independent computing devices can be electronically created, managed and dispersed using an electronic syndicated lottery platform, system and method for making a collective electronic wager on a lottery offering (e.g., a lottery drawing) or non-lottery offering. Groups can be formed of co-workers, friends, social media contacts, etc. using one or more independent computing devices. Each group, or a lead player, can decide in advance as to how winnings will be divided, and electronically represent their independent rules in the system. In various embodiments, the system can operate so as to automatically and simultaneously distribute winnings to all players in the group once it has been determined that a win has occurred.

In various embodiments, with a first software module, the system receives an electronic request from an independent personal computing device to establish a group primary wagering game, wherein the request includes a designation of a specific number of players or a range of a number of players to be included in a wagering group, and further includes at least one type of wagering game to be played that is available from the syndicate platform, and further receives a designation of one or more players to be invited to join the wagering group, wherein each of the one or more players has a player transaction account. With a second software module, the system electronically collects payment for the group primary wagering game, electronically registers the wagering game to be played with a game operator, electronically determines whether a win has occurred and, upon a win occurring, automatically credits the player transaction accounts in the wagering group.

### BRIEF DESCRIPTION OF THE DRAWINGS

FIG. 1 is a sample schematic diagram illustrating components of a system in accordance with embodiments of the present invention.

FIG. 2 is a flow diagram illustrating example scenarios in accordance with embodiments of the present invention.

FIGS. 3 through 5 are schematic illustrations of group play in accordance with aspects of the present invention.

FIG. 6 is an exemplary user interface in connection with embodiments of the present invention.

### DESCRIPTION OF EMBODIMENTS

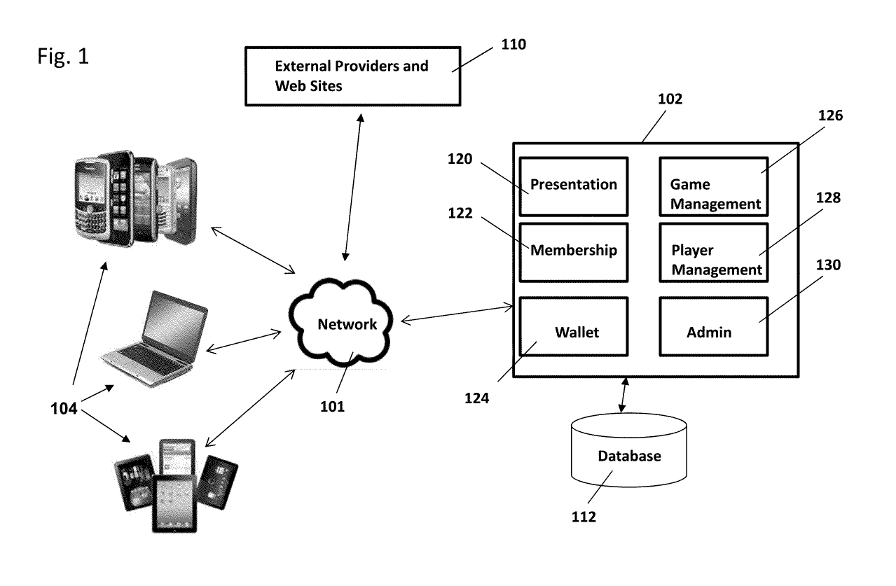

FIG. 1 is a schematic diagram illustrating an exemplary system 102 for facilitating electronic syndicate lottery activities in accordance with various network-enabled and/or online embodiments of the present invention. As shown therein, embodiments of the system can comprise a computer-based system 102, where the components and/or modules can be implemented in hardware, software, firmware, or combinations thereof. FIG. 1 illustrates an exemplary high-level network 101 with exemplary users and/or external computer systems 104 that can interact with the system 102 of the present invention. The users can access the system of the present invention using client computing devices 104, such as desktop computers, laptop computers, mobile communications devices (MCDs), smart television appliances or one or more public game terminals or kiosks in appropriate commercial sites, subject to any jurisdictional limitations, for example. It will be appreciated that the system of the present invention can incorporate necessary processing power and memory for storing data and programming that can be employed by the processor to carry out the functions and communications necessary to facilitate the processes and functionalities described herein.

Players can enter commands and information into respective client computing devices through a user interface including traditional input mechanisms, such as a keyboard and pointing device, commonly referred to as a mouse, trackball or touch pad. Other input devices can include, for example, a microphone, joystick, game pad, satellite dish, scanner, voice recognition device, keyboard, touch screen, toggle switch, pushbutton, gesture based motions or the like. One or more monitors or display devices can be provided with the player's computing device or game terminal as will be understood in the art. In addition to display devices, the computing devices can also include other peripheral output devices, which may be connected through an output peripheral interface. The computers implementing the invention may operate in a networked environment using logical connections to one or more remote computers, the remote computers typically including many or all of the elements described above.

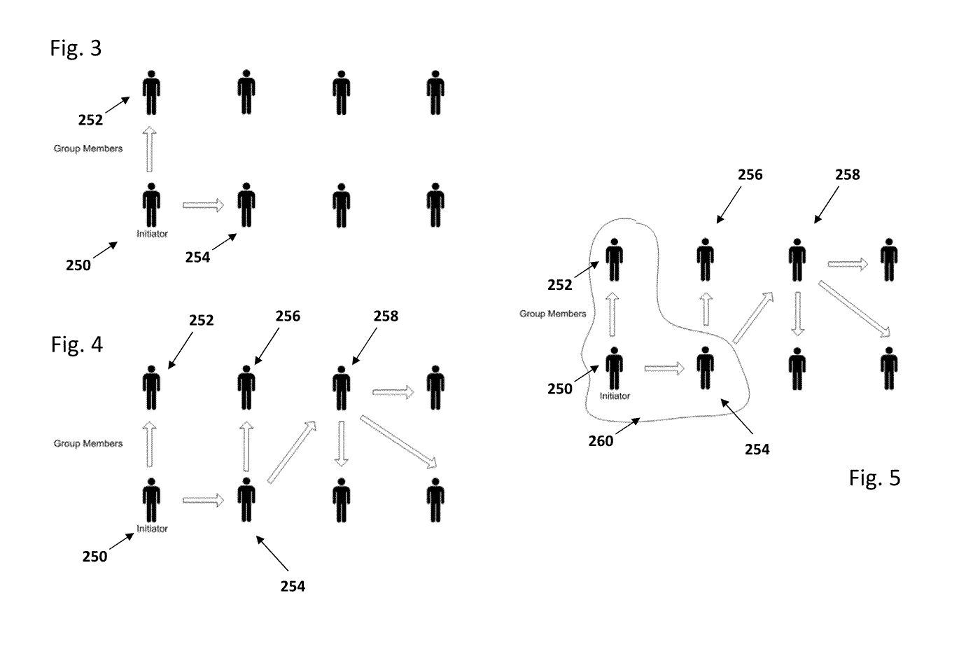

As further shown in FIG. 3, the system 102 can include a presentation or user interface module 120, a player membership module 122, a player wallet module 124, a game management module 126, a player management module 128 and an administrative module 130, and further can be coupled to one or more databases 112 and/or other data sources. These software modules can be programmed or configured to communicate with one another and with the databases 112. The modules can be recorded on a non-transitory computer-readable medium and include programming instructions to conduct the steps and processes associated therewith. The system of the present invention can execute these software modules to facilitate the lottery-type games and processes in accordance with embodiments of the present invention as described herein. The databases 112 hold records related to players and games, including winning combinations, player selections, player and group rules, game presentations and functions, player opt-in permissions, group creation, group wagering, group disbandment and other information and functions. In various embodiments of the present invention, the system of the present invention is in communication with external service providers and web sites 110, such as government lotteries, banking service providers who may provide credit or payment transaction services for players, and social media sites that may provide access to player profile information and/or player personal network information, for example.

Each of the client computing devices 104 can communicate with the system 102 via a user interface presentation module 120. The presentation module 120 provides computer and/or Internet access for players and game operators/administrators to communicate with other devices and various modules. In various embodiments, the user interface can permit, among other things, player login, player invitations, winner notifications, group and sub-group selections, all-or-nothing and divided winning selections, auto-renew inputs, favorite number inputs and other electronic interactions. The player membership module 122 performs functions related to registering new players, such as verifying player information, assigning player IDs, and creating player records. The wallet module 124 manages player accounts and handling debit and credit transactions against the player accounts, including wagering and winner payouts. The game management module 126 performs functions such as scheduling and conducting lottery drawings and other games and drawings, generating and publishing game results, comparing the results to player selections, calculating payout amounts, presenting options to players upon game setup, implementing selected options (such as, for example, extending winnings to a subsequent game or conducting an independent drawing for a winner-take-all award), and similar electronic functions. The player management module 128 contains and manages data records related to each player, including, for example, player identification data, registration information, wager preferences, account history, games played history, game outcomes history, game selections history, group membership history for games played, social network information, group memberships and opt-in information. The administrative module 130 facilitates administrative and customer service tasks to be performed by a system operator, for example. The administrative module can further provide API's such as a back-end application programming interface to social media sites, for example.

In operation, a player can employ embodiments of the present invention to establish an electronic syndicated wager with various payout options, including immediate divided payout to multiple participating players simultaneously upon a win determination. In establishing a game for a player or group, the system (via presentation module 126, for example) can prompt the user to establish rules of operation, which can include factors such as, number of players permitted, whether players can invite other players into the group, how group players can be dropped, whether there will be any threshold winning amounts that determine post-winning functions, whether the group will split any winnings equally or on a pro rata basis, whether the group will pool winnings into a winner-take-all subsequent game, whether the group will include other groups as individual members, whether second-chance play will be available as a group or individually, and other rules. Based upon the game setup, the system of the present invention can incorporate additional electronic operations after the initial game. In at least one embodiment, the additional electronic operations depend upon whether the group won or lost the initial game, in accordance with how the game has been originally set up by the controlling player or group. In various embodiments, after an initial win, the system can electronically present a second chance drawing opportunity, whereby a second chance draw will occur. In such embodiments, the system can electronically query the group individually (such as via a group leader) or collectively to receive a selection of whether to operate the second chance drawing with an all-or-nothing outcome (i.e., one person wins the entire prize) versus split shares, where the group members share in any winnings In various embodiments, the group can electronically request that the system conduct a private second drawing to determine a single winner for the group's winnings The group or controlling individual can also electronically establish thresholds that determine what transpires after a group win. For example, if the group wins $500 or less, the winnings are evenly distributed, but if the group wins more than $500, a second drawing will be conducted to determine a single winner. It will be appreciated that the initiator can specify multiple thresholds with individualized handling of winnings depending upon the rules established for each threshold by the initiator. In embodiments of the present invention, the system permits one player to electronically pre-establish rules for operating the wagering game. In other embodiments of the present invention, the system permits one or more players of a group to electronically provide input “on-the-fly” as the game is operating (and not in pre-established fashion) to influence additional operations after an initial game. For example, after an initial drawing and a second chance drawing, assume that the winnings are to be awarded to a group of five individuals. The individuals may electronically elect to have a subsequent drawing to provide an all-or-nothing award, such that only one of the five individuals will receive the full award, and the remaining four will receive nothing. In this way, the players are providing electronic input as the game is operating and not in pre-established fashion.

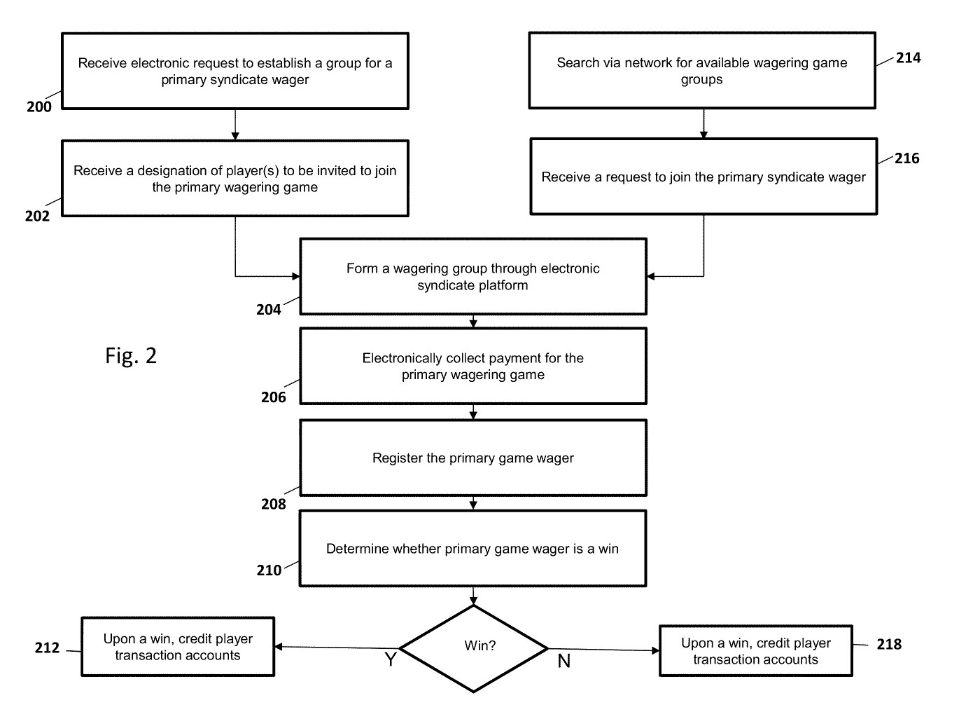

In one aspect, after an initial loss, each player is automatically and electronically entered into a second chance drawing for additional prizes that are not part of the original lottery drawing. Exemplary win and loss scenarios are shown in FIG. 2. Regardless of whether a player or group wins or loses in the initial game, the system of the present invention can electronically offer each individual player an option for further participation after the initial game is played. For example, each player can either start a new game through new, independent electronic communications for the next draw, replay the same wager, have an “auto-renew” feature electronically enabled, or just leave the group and quit.

With further reference to FIG. 2, an exemplary process in accordance with aspects of the present invention can occur as shown therein. For example, at step 200, the presentation module 126 electronically receives a player request to establish a group primary wagering game. The receiving function can be performed, for example, by software instructions stored in a computer memory associated with system 102 and executed by the presentation module 120 so as to process input from a player device 104 connected to system 102. At step 202, the presentation module 120 receives a player designation of one or more players to be invited to join the group wagering game. Invited players can be selected by the initiator using previously stored contact information, either within the system 102 or externally such as through social media applications, for example, or through newly entered contact information, for example. Invited players can have previously established accounts with the system 102, or can be invited to create an account in order to participate further in the syndicate activity. At step 204, the group is formed, which can involve the system electronically processing information from the presentation module and coordinating information flow with one or more modules, including the player membership module 122, the wallet module 124 and the game management module 126, for example. For instance, the system can electronically check that the received player designation information corresponds to players that have already registered and established a player account and/or wallet. As such, the system can then electronically process payments for wagers and credits for any winnings The system can further send a communication such as an electronic mail message or text message to each player who has been invited to be a participant in the group wager. If the player elects to participate, he or she can be electronically prompted by the system, via wallet module, for example, to authorize the payment for the player's participation to be processed as a deduction from the player's registered account. Players who decline participation or do not respond are withheld from the group.

Once the group is formed and payments collected, as at step 206, the game management module 126, for example, can arrange for the wager to be registered with the operating game authority (e.g., a government lottery), as at step 208. As part of this process, the player initiating the group wagering game can, via the presentation module 120, select the wagering game to be played (e.g., a lottery drawing), designate a number of games to be played, designate the specific game (e.g., MegaMillions™), designate a price for the game(s), designate either the selected numbers to be played or a “quick pick” selection, where the numbers for the game can be randomly and automatically generated (e.g., by the game management module 126). It will further be appreciated that the player initiating the group wagering game can, via the presentation module, select a group icon or avatar to act as the group's symbol, select whether the game is public or private, and provide game and payout operating instructions. For example, the player can designate whether there will be any threshold winning amounts that determine post-winning distributions, whether the wagering group will split any winnings equally or on a pro rata basis, and/or whether the group will pool winnings into a winner-take-all subsequent game, for example.

At step 210, the game management module 126 or another software module can conduct the game to determine whether the primary game wager is a winner. In doing so, the registered wager is compared with game results to determine if and how many numbers were matched. If the game is determined to be a winner, at step 212, the wallet module 124 can payout the winnings to each of the player accounts associated with the players participating in the group. The player management module 128 can manage data records related to each player, including, for example, the group name, the group wager selections, the winning numbers drawn, the wager payment, the winning payout and other details. In various embodiments, the presentation module 120 associated with the system can also, prior to crediting player accounts, send a message to each participating player to elect whether to use all or a portion of the winnings to re-enter a future wagering game manually for the next draw, enable an “auto-renew” feature to have the wager automatically renewed, or just cash out with the winning

As further shown in FIG. 2, an individual who was not invited to participate by the initiating player can use the system of the present invention to search for group wagers that may be joined. In this regard, the presentation module 120 can be electronically employed to search for group wagering games that have not fully been formed, but that are open to the public to be formed. Such wagering groups need not be, but may be, organized by themes, such as sports team fans, geographic regions, schools, etc. A player can electronically search as at step 214 for such public groups using the presentation module 120, and upon finding a desired group to join, can send a request that the system receives in order to initiate that player joining the selected group, as at step 216. It will be appreciated that the player may be able to join the group unilaterally upon the player's request, or there may be an approval process whereby the player initiating the group game can approve the requesting player upon being notified by the system that the additional player wishes to join. Regardless, if and when the player is joined into the group, the same steps 204-212 as described above can be performed.

As further shown in FIG. 2, if the game drawing for the primary wagering game results in a loss, players can become participants in a second chance game as at step 218 and described elsewhere herein.

In embodiments of the present invention, an entity that is a party to a group wager need not be an individual person, but can be a group in and of itself. Thus, the present invention permits an initiator to be an individual person or a group, and further permits subsequent participants to be an individual person or a group. The nesting of groups can generate very exciting chains of second chance drawings and other wagering games. For example, the encircled group of three players 260 in FIG. 5 may be a group. This group may win a share of winnings from full group play (with all eight of the players in FIG. 5 participating), or may win one hundred percent of the winnings from full group play, depending upon player selections and game outcomes. As a hypothetical example, if this group of three players wins one hundred percent of the second chance drawing for the full group, the system may offer for this group of three to have an additional second chance drawing (effectively a third drawing) in which the individuals in the group of three may win all of the winnings from the second chance drawing. Hypotheticals with larger sample sizes can be easily imagined, and in many cases, these games can allow for a very long time when the prize is still “at stake” among at least a portion of the participants in one or more of the groups involved. In this way, the present invention facilitates a long-term interest in game play, which not only maintains player attention during the game, but also attracts players to the game from the outset.

In additional aspects, the present invention incorporates social wagering functions permitting the electronic creation of user-generated content around a pool of wagers, wherein the wagers may or may not be tied to a lottery drawing. For example, wagers can be made regarding private raffles that are not associated with a public lottery. In embodiments of the present invention, user-generated content and relationships drive the distribution of lottery tickets and permit groups of players to define their own game parameters. For example, a player can electronically define the draw date/time, prize structure they want to play for, pool size, price per share and so forth. The player can then electronically invite or promote the game across social media or at an event asking people to join their game. The game management module 126 can execute the game as an individual or private lottery drawing, for example.

Embodiments of the present invention can be exemplified in several ways. For example, at the start of a professional football game, the home team's marketing staff may use embodiments of the present invention to promote a game on the large video screen. In this case, the game is a raffle style game where twenty-five lucky winners will win a percentage of the pot.

The draw time is set for some pre-determined time that is expected to be when the game is still being played, and thus the fans are still in the stadium. Fans at the stadium can use their mobile devices to purchase tickets from a designated website, which may optionally be integrated with the state-run lottery system. At the appointed time, the state-run system draws the winners and notifies all players via mobile device as well as on the stadium screen.

As another example, a state chapter of a non-profit, charitable organization may electronically host a game where players can purchase tickets for a rolling jackpot style game. They invite everyone from three independent fundraisers to join the game where all winnings go to the non-profit's fund. The game is scheduled to end on a pre-determined date. Everyone who donated a chance is notified of the final win amount which was donated. As a further example, a family of four is planning their big family picnic next month and decides to add a fun game to a list of other activities planned for the day. In this case, the day will be started off with a chance to win cash prizes in addition to an all-expense paid cruise for twenty people. The drawing is scheduled for the kickoff of the party, and the family adds appropriate notices on the family picnic website and the invitation.

In embodiments of the present invention, a syndicate can be created without an official syndicate manager. Instead, there is an initiator who creates the user-generated content around the pool of wagers. For example, as shown in FIGS. 3 through 5, an initiator may decide to create a new wagering pool via a website, such as Twitter™, for example. The initiator may call the new pool “Irate Pirates”, since it relates to an annual festival he attends with old friends using that name. The initiator includes information about the event and a schedule of where he plans to be each day of the festival. In addition, the initiator electronically marks the pool private which means only people who are invited may enter the pool; thus, the pool is not open to the public. The initiator then electronically sets the price point and picks a prize structure or prize. In embodiments of the present invention, as soon as the first wager is placed in the pool by the initiator of “Irate Pirates”, he/she can now electronically send it to any of his friends on using a social media website, for example. As depicted in FIGS. 3 through 5, the initiator 250 electronically sends the pool through the website to two friends 252, 254 who always attend the event each year with him. They each decide to join the pool and place a wager. The first friend, 252, adds a few wagers and then adds a comment to the pool that he will be attending and will meet the initiator at the first place on his schedule. The other friend, 254, that the initiator 250 sent the pool to adds a few wagers as well. The friend, 254, then decides to invite some more friends 256, 258 who he thinks might be interested in either the pool or the festival. This continutes until the actual start date of the event when the pool closes and the wagers start to get placed from the pool. In embodiments of the present invention, since the initiator 250 only knows the first two people he invited (252 and 254), the initiator 250 is only able to see those people in the pool in any associated visual interface representing the group, as illustrated in FIGS. 4 and 5, for example.

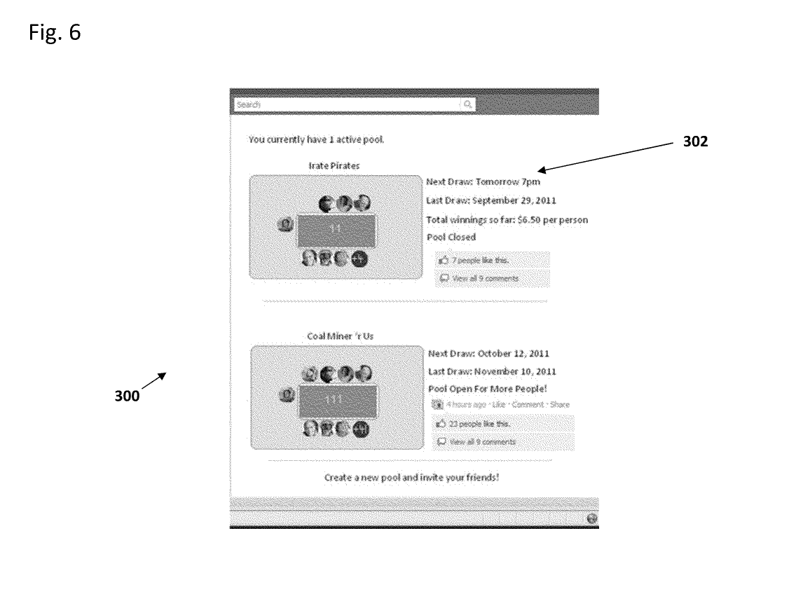

FIG. 6 provides an example of a user display screen 300 presented by embodiments of the system of the present invention in accordance with the aspects just described above. In this case, each pool the user belongs to has a date and time (e.g., as at 302) on which it opens and closes.

It will be appreciated that when a pool is closed, players can no longer join the pool. It will further be appreciated that players can belong to multiple pools. Thus, as described, aspects of the present invention accommodate groups of people making wagers but, unlike a syndicate, there is no official syndicate manager. Instead, there is an initiator who creates the user-generated content around the pool of wagers. It will further be appreciated that there need not be a direct link to the lottery or other random number determination mechanism. It will be appreciated that embodiments of the present invention permit membership in multiple pools, permit closed versus open pools, permit non-initiators to notify their social graph to obtain interest in a wager opportunity, and permit the limitation of any user's view of others in the pool to those in the user's social graph, for example.

According to the above description and the drawings, it can thus be seen that the embodiments of the present invention provide an electronic syndicated lottery platform, system and method. In various embodiments, the present invention can be implemented with a front-end user interface/link to social media sites such that the user can log in using social media site credentials in order to play. In another embodiment of the present invention, a back-end application programming interface (API) to social media sites is provided. In operation, the present invention can be provided so as to operate only for registered game/lottery players, following necessary jurisdictional requirements, wherein, for example, an electronic check is made of the player's qualification to participate according to geospatial positioning determination(s) and/or stored profile information. A registered game player will have previously created an account containing, for example, identity information, contact information such as an e-mail address, and credentials such as a password in order to be able to log in and conduct future activities as a registered player. Optionally, the registered player can also enter other player profile details within his or her account, including playing preference information, notification preference information, one or more player icons (such as a photographic image or avatar, for example), and personal interest information such as hobbies, sports, music, food, animals and similar interests, for example. In one embodiment of the present invention, notification information can include a request to notify the player's preferred social media site that one of his or her friends or designated player icons has been involved in some type of event within game play, such as, for example, being invited to participate in a group, etc. A registered player can access and play a game according to the present invention by, for example, logging in to a dedicated website for game play, using log-in credentials specifically established for the game of the present invention. As an alternative example, the player can login to a dedicated website for game play in accordance with the present invention using his or her preferred social media network/profile, and the present invention can recognize the player as a registered player through his or her unique e-mail address and/or personal or profile information.

Aspects of the present invention can operate with traditional print tickets, tickets purchased and/or played over the Internet, and tickets purchased as part of a subscription. Games implemented via the platform according to embodiments of the present invention can involve an electronic instant ticket, electronic draw-based tickets, a video lottery terminal game, a “play for fun” game with no monetary value, a game that awards credits or prizes instead of money, a mobile application game, a Bingo game, a slot game, a Keno game, a poker game, a game that is revealed on a monitor and other games.

Unless otherwise stated, devices, modules or components associated with the present invention that are in communication with each other do not need to be in continuous communication with each other. Further, devices, modules or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, satellite, EDGE and EVDO, for example. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

1. A system, comprising:
a first software module, wherein the first software module is recorded on a non-transitory computer-readable medium and includes programming instructions to:
receive a request to establish a primary syndicated wager, wherein the request includes a designation of a specific number of players or a range of a number of players to be included in a wagering group, and further includes at least one type of wagering game to be played; and
receive a designation of one or more players to be invited to join the wagering group, wherein each of the one or more players has a player transaction account;
at least one second software module, wherein the at least one second software module is recorded on a non-transitory computer-readable medium and includes programming instructions to:
collect payment for the group primary wagering game;
register the wagering game to be played with a game operator;
determine whether a win has occurred; and
upon a win occurring, automatically crediting the player transaction accounts in the wagering group.

2. The system of claim 1, wherein the request includes a designation of a number of games to be played.

3. The system of claim 1, wherein the designation of at least one type of wagering game to be played includes a designation of a lottery drawing game, a number of lottery drawing games to be played and a price.

4. The system of claim 3, wherein the designation of a lottery drawing game further includes a designation of at least one of selected numbers to be played or a quick pick selection.

5. The system of claim 1, wherein the request includes a designation of a group icon.

6. The system of claim 1, wherein the request includes a designation as to whether the game is public or private.

7. The system of claim 1, wherein the request includes an instruction as to whether there will be any threshold winning amounts that determine post-winning distributions.

8. The system of claim 1, wherein the request includes an instruction as to whether the wagering group will split any winnings equally or on a pro rata basis.

9. The system of claim 1, wherein the request includes an instruction as to whether the group will pool winnings into a winner-take-all subsequent game.

10. The system of claim 1, further including at least one third software module, wherein the at least one third software module is recorded on a non-transitory computer-readable medium and includes programming instructions to:
receive a request to join a public group wagering game from at least one outside player; and
provide information about the public group wagering game to a user interface accessible by the at least one outside player.

11. The system of claim 1, further including a storage software module, wherein the storage software module is recorded on a non-transitory computer-readable medium and includes programming instructions to store player data for at least one player of the group wagering game, including player identification data for the at least one player, games played by the at least one player, game outcomes of the games played by the at least one player, player selections for the games played and group rules for the games played.

12. The system of claim 1, wherein the request includes a designation that a secondary wagering game be conducted in the event that any winnings associated with the primary syndicated wager do not meet a minimum threshold.

13. The system of claim 4, further including at least one third software module, wherein the at least one third software module is recorded on a non-transitory computer-readable medium and includes programming instructions to:
receive from the designated one or more players an instruction related to a future game not involving the primary syndicated wager, wherein the instruction is at least one of replaying the same selected numbers as the primary syndicated wager, initiating a new wagering game and auto-renewing a previous wager.

14. The system of claim 1, wherein at least one of the designated players encompasses a plurality of players.

15. The system of claim 1, wherein upon a win not occurring, the second software module of the server enters each player of the wagering group into a drawing for additional prizes, wherein the drawing is not part of the primary wagering game.

16. A method, comprising:
with a first software module, wherein the first software module is recorded on a non-transitory computer-readable medium and includes programming instructions to:
receiving a request to establish a primary syndicated wager, wherein the request includes a designation of a specific number of players or a range of a number of players to be included in a wagering group, and further includes at least one type of wagering game to be played; and
receiving a designation of one or more players to be invited to join the wagering group, wherein each of the one or more players has a player transaction account;
with at least one second software module:
collecting payment for the group primary wagering game;
registering the wagering game to be played with a game operator;
determining whether a win has occurred; and
upon a win occurring, automatically crediting the player transaction accounts in the wagering group.

17. The method of claim 16, wherein the step of receiving a request includes receiving a designation of a number of games to be played.

18. The method of claim 16, wherein the step of receiving a request includes receiving a designation of a lottery drawing game, a number of lottery drawing games to be played and a price.

19. The method of claim 18, wherein the step of receiving a request includes receiving a designation of at least one of selected numbers to be played or a quick pick selection.

20. The method of claim 16, wherein the step of receiving a request includes receiving a designation of a group icon.

21. The method of claim 16, wherein the step of receiving a request includes receiving a designation as to whether the game is public or private.

22. The method of claim 16, wherein the step of receiving a request includes receiving an instruction as to whether there will be any threshold winning amounts that determine post-winning distributions.

23. The method of claim 16, wherein the step of receiving a request includes receiving an instruction as to whether the wagering group will split any winnings equally or on a pro rata basis.

24. The method of claim 16, wherein the step of receiving a request includes receiving an instruction as to whether the group will pool winnings into a winner-take-all subsequent game.

25. The method of claim 16, further including, with at least a third software module:
receiving a request to join a public group wagering game from at least one outside player; and
providing information about the public group wagering game to a user interface accessible by the at least one outside player.

26. The method of claim 16, further including, with a storage software module, storing player data for at least one player of the group wagering game, including player identification data for the at least one player, games played by the at least one player, game outcomes of the games played by the at least one player, player selections for the games played and group rules for the games played.

27. The method of claim 16, wherein the step of receiving a request includes receiving a designation that a secondary wagering game be conducted in the event that any winnings associated with the primary syndicated wager do not meet a minimum threshold.

28. The method of claim 19, further including, with at least a third software module:
receiving from the designated one or more players an instruction related to a future game not involving the primary syndicated wager, wherein the instruction is at least one of replaying the same selected numbers as the primary syndicated wager, initiating a new wagering game and auto-renewing a previous wager.

29. The method of claim 16, wherein step of receiving a request includes receiving a designation of at least one player that encompasses a plurality of players.

30. The method of claim 16, wherein upon a win not occurring, the second software module of the server enters each player of the wagering group into a drawing for additional prizes, wherein the drawing is not part of the primary wagering game.
